(19) United States
(12) Patent Application Publication
(10) Pub. No.: US 2004/0012638 A1
(43) Pub. Date: Jan. 22, 2004

(54) System and method of electronic commitment tracking

(76) Inventors: Richard K. Donnelli, Richardson, TX (US); Thomas F. Samson, Coppell, TX (US); Chris Rathman, Richardson, TX (US); Neil Simon, Plano, TX (US)

Correspondence Address: HAYNES AND BOONE, LLP, 901 MAIN STREET, SUITE 3100, DALLAS, TX, 75202, US

(21) Appl. No.: 10/444,248

(22) Filed: May 23, 2003

Related U.S. Application Data
(60) Provisional application No. 60/383,029, filed on May 24, 2002.

(51) Int. Cl. G09G 5/00

(52) U.S. Cl. 345/772

(57) ABSTRACT

An electronic system and method of commitment completion for execution within a remote computing system is provided, comprising storing at least one commitment to be accomplished by a group of individuals in an electronic medium, a plurality of commitments related to the commitment and completion dates associated with the plurality of commitments. The method further contemplates assigning at least one individual as a responsible party for each commitment. The system may then be controlled to compare the stored completion dates to the current date and compare the current status of a commitment to the expected status on the current date. The computing system may generate a visual representation of the group progress toward realizing the at least one commitment by displaying a plurality of the commitments with display features indicating the progress toward completion.

### RELATED PROVISIONAL PATENT APPLICATION

This application claims priority to U.S. Provisional Patent Application Serial No. 60/383,029, filed May 24, 2002, entitled System and Method of Electronic Commitment Tracking, the entirety of which is hereby incorporated by reference.

### FIELD OF THE INVENTION

The present invention relates generally to automated systems and methods for electronic commitment tracking. More specifically, the present invention provides a system and method for individual and group commitments and sub-commitments, as well as issues related to those commitments and sub-commitments in order to achieve those commitments over a period of time and communicating with the members of the group the status of the commitments, sub-commitments, and issues.

### SUMMARY OF THE INVENTION

The present invention provides a system and method of electronic commitment tracking that can be accomplished by storing at least one commitment and storing a review time period associated with the commitment. The color of a graphical depiction of the commitment based on the status of the review time period is changed, and a status of the commitment based on the status of the review time period is updated. In addition, electronic commitment tracking can be accomplished by storing a list of names of a plurality of individuals and receiving an electronic document. An electronic communication to a plurality of electronic addresses corresponding to the plurality of individuals is sent and a graphical representation of a first commitment to at least one of the individuals is displayed. The electronic document to the at least one individual is displayed, and information from the at least one individual with respect to the status of the first commitment is received. Based on the information, a status of the first commitment is updated based on the status of the first commitment a status of a second commitment is updated. Further, electronic commitment tracking can be accomplished by storing a list of names of a plurality of individuals and sending an electronic communication to a plurality of electronic addresses corresponding to the plurality of individuals. A graphical representation of a first commitment to at least one of the plurality of individuals is displayed and an electronic document is received from the at least one individual. Information from the at least one individual with respect to the status of a second commitment is received. A graphical representation of the second commitment such that the graphical representation is logically connected to the electronic document is displayed, and then the electronic document is displayed. Additionally, a method of electronic commitment tracking can be accomplished by storing a plurality of commitments and storing an issue relating to at least one of the commitments. A graphical representation of the plurality of commitments is displayed and a graphical representation of the issue such that the graphical representation is logically connected a graphical representation of an issue tree is displayed. The graphical representation of the issue tree is displayed, and information with respect to a status of one commitment of the plurality of commitments is received. The graphical representation of the issue is updated.

### DESCRIPTION OF THE DRAWINGS

FIG. 1 is an illustration of one embodiment of the system of electronic commitment tracking.

FIG. 2 is an illustration a node that could be used to implement an embodiment of the invention.

FIG. 3 is an example graphical representation of a people module.

FIG. 4 is an example graphical representation of a commitment module.

FIG. 5 is an example graphical representation of receiving an electronic document.

FIG. 6 is an example graphical module.

FIG. 7 is an example representation of an issue tree.

FIG. 8 is an illustration of the flow of an embodiment of the invention.

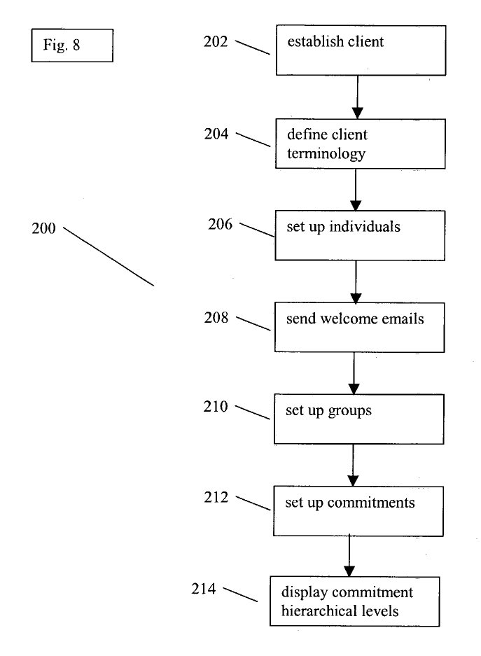

FIG. 9 is an illustration of the flow of another embodiment of the invention.

FIG. 10 is an illustration of the flow of further embodiment of the invention.

FIG. 11 is an illustration of the flow of an additional embodiment of the invention.

FIG. 12 is an illustration of the flow of another embodiment of the invention.

### DETAILED DESCRIPTION

The following disclosure provides many different embodiments, or examples, for implementing different features of a system and method for accessing and managing structured content. Specific examples of components, processes, and implementations are described to help clarify the invention. These are, of course, merely examples and are not intended to limit the invention from that described in the claims. Well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art.

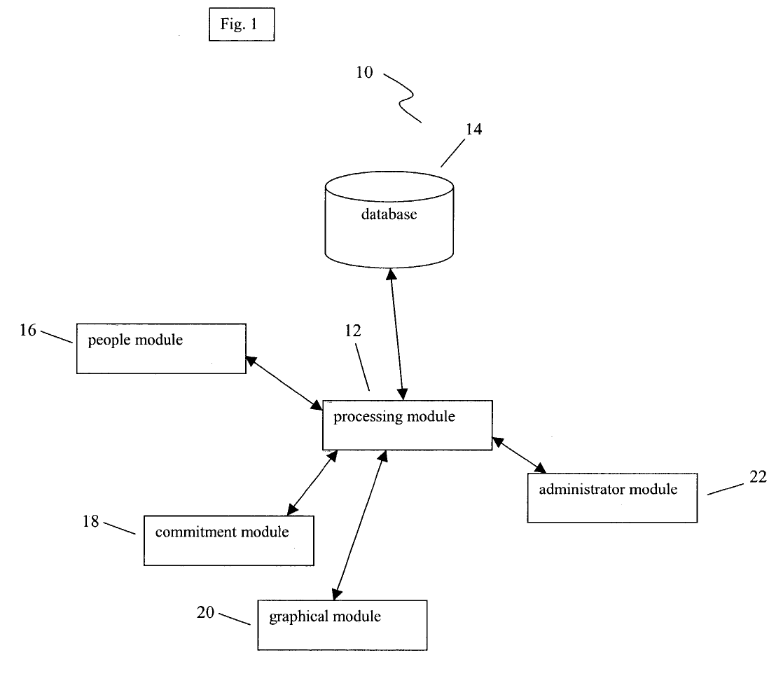

Referring to FIG. 1, one embodiment 10 of the system of electronic commitment tracking is shown. A processing module 12 is in communication with a database 14. In communication with the processing module 12 is people module 16, commitment module 18, and graphical module 20.

The processing module 12 handles and routes all incoming requests and data from all of the other modules, as well facilitating communication with the database 14 for each of the modules.

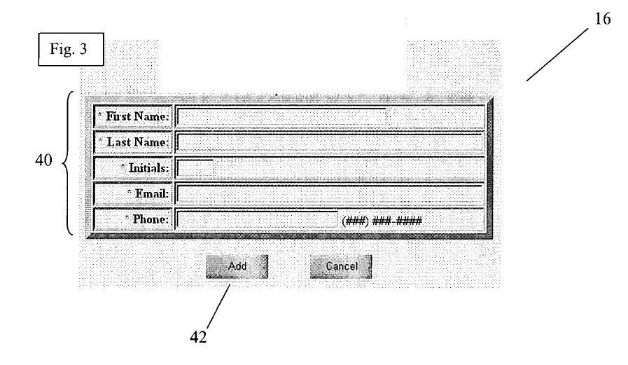

A client is a person or entity for whom a particular commitment or accomplish is to be set. Example clients are corporate entities, but could be operating divisions or individuals. The people module 16 receives input from a user with respect to the individuals who are intended to participate with respect to a client. A visual representation of the people module 16 is show in FIG. 3. In this example, the people module 16 is represented using an HTML form. A user of the system uses people module 16 to input the contact information of each person that may participate in attempting to achieve a commitment for a client. Once the user enters information into the people module 16, the people module 16 submits the information to the processing module 12.

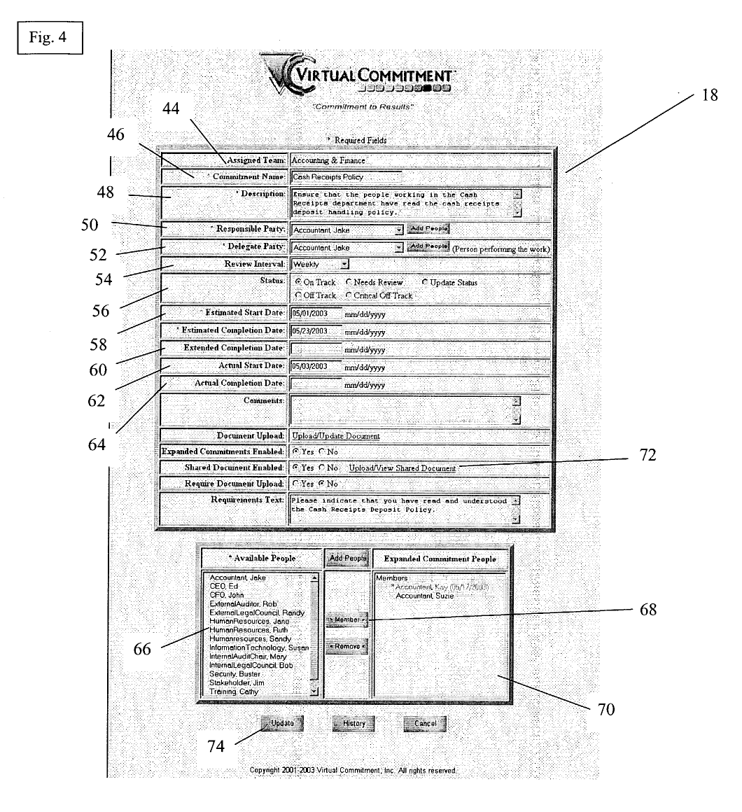

The commitment module 18 receives input from a user with respect to the commitments that are intended to be achieved with respect to a client. A visual representation of the commitment module 18 is shown in FIG. 4. In this example, the commitment module 18 is represented using an HTML form. The first commitment entered is the commitment. Multiple commitments may be entered in a hierarchical fashion. The commitment (and any sub-commitments) are the only commitment types that is not only assigned to a responsible party, but is also assigned to a group. The second hierarchical tier is a sub-commitment. The sub-commitment can have unlimited hierarchical levels and is used to connect common relational commitment types to a common purpose to the next hierarchical level directly above. The sub-commitment may trigger color coding changes for the next hierarchical level directly above. The third level hierarchical commitment tier is the strategy and only contains one hierarchical level deep. The strategy is not assigned to a group, but rather a responsible party. The strategy may trigger color coding changes for the next hierarchical level directly above. The fourth level hierarchical commitment tier is the action plan and only contains one hierarchical level deep. The action plan is also not assigned to a group, but rather a responsible party. The action plan may trigger color coding changes for the next hierarchical level directly above. The fifth and last hierarchical level commitment tier is the commitment and contains unlimited number of commitments per relationship with an action plan. This last commitment level is also the core interaction level driving automated features and triggering color coding changes for the next hierarchical level directly above.

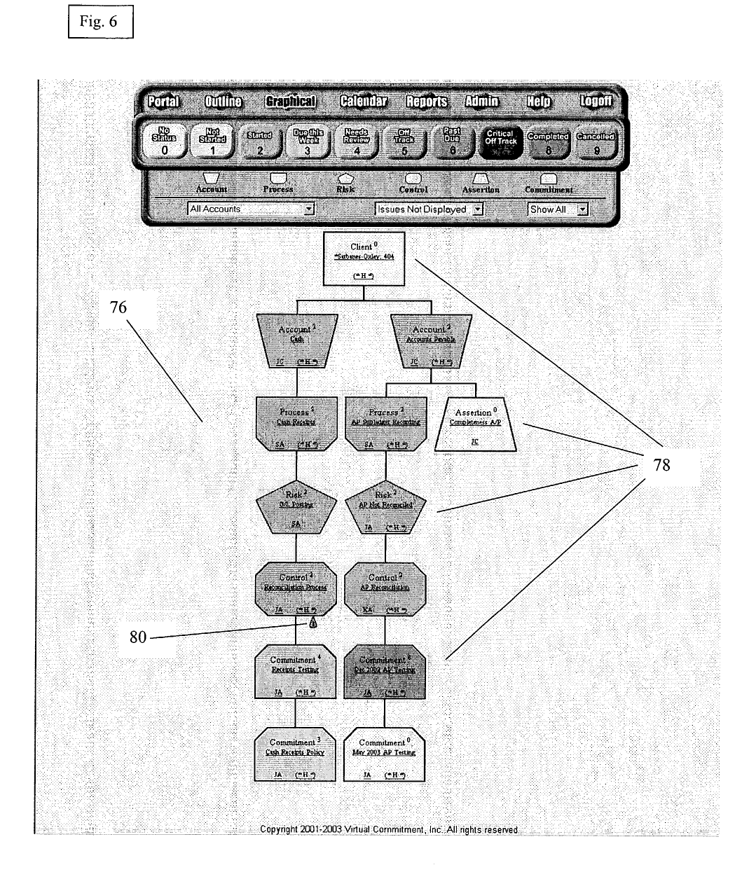

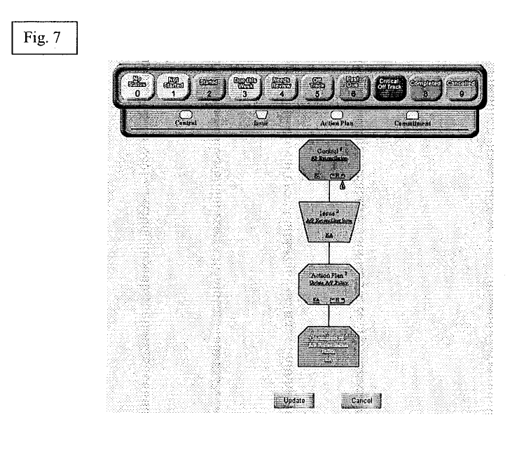

The graphical module 20 communicates with the processing module 12 to display the commitment hierarchical levels and individual commitment graphical diagrams of the system. The graphical display of commitment types (commitments, sub-commitments, strategy, action plan, commitment) are uniquely shaped and the status (associated with color coding) for each commitment results from a number of instances affecting the individual commitment types. The graphic module 20 may communicate with the processing module 12 to display a calendar showing the status of the commitments. The graphic module 20 may also communicate with the processing module 12 to display reports based on the data in the database, which may also involve a report query tool that allows the display and sorting of the data contained in the database 14. Examples representations of the graphical module are shown in FIG. 6 and FIG. 7.

The administrator module 22 permits a user to access a number of administrative features of the system. Such features may include: people demographic directory, people portal directory, logon name/password, edit demographic information, change logon name/password, remove unassigned people, import people, add group consultant, remove unassigned group consultant, restore group consultant, assign facilitator, unassign facilitator, assign observer, unassign observer, and change client terminology.

The people demographic directory feature allows a user to view an alphabetical listing of the people that have been setup in the system and when a person is selected, their demographic and contact information may display. The administrator module 22 may also display a date next to the person's name indicative the last time that the person accessed the system. If there is not a date next to their name, the individual has never logged into the software system.

The people portal directory allows a user to view an alphabetical listing of the people that have been setup in the system and when a person is selected, a portal page (e.g. a web page) that is personalized to the person may display. This personalized portal page may display the groups the person is participating on, as well as a listing of all the commitments to which the person is assigned as the responsible party or delegate party.

The check user logon name/password features allows a user to view an alphabetical listing of the people that have been setup in the system and when a person is selected, the person's system logon User Name and Password are displayed.

The edit demographic information feature displays the demographic information and contact information for the person that is accessing the system.

The change logon name/password feature displays the system logon User Name and Password for the person that is accessing the system.

The remove unassigned people feature displays a dropdown list of people that are not assigned any commitments and allows the removal of the person from the system.

The import people feature allows the details of a person to be imported from one client to this current client. A dropdown list of available clients can be displayed, and upon selecting a client from the list, a second dropdown box may appear that lists the people for that client. The user can then select a person from this list and the selected person may then be added to the available people list for this current client. In this manner, a person may be assigned to multiple clients and only have one User Name and Password for use on all clients. In one embodiment, this feature is only accessible by those with “Facilitator” (or higher) access rights.

The add group consultant feature allows the setup into the software system of a new “Group Consultant”. In one embodiment, this feature is only accessible by those with “Group Consultant” (or higher) access rights.

The remove unassigned group consultant allows the removal of an existing Group Consultant. In one embodiment, this feature is only accessible by those with “Group Consultant” (or higher) access rights.

The restore group consultant feature allows a “Group Consultant” that has been removed from the software system to be setup again. In one embodiment, this feature is only accessible by those with “Group Consultant” (or higher) access rights.

The assign facilitator feature allows a “Facilitator” to be setup for the current “client”. In one embodiment, this feature is only accessible by those with “Group Consultant” (or higher) access rights.

The unassign facilitator feature allows a person that has been setup as a “Facilitator” for the current “client” to be removed from this role. In one embodiment, this feature is only accessible by those with “Group Consultant” (or higher) access rights.

The assign observer feature allows an “Observer” to be setup for the current “client”. In one embodiment, this feature is only accessible by those with “Facilitator” (or higher) access rights.

The unassign “Observer” feature allows a person that has been setup as an “Observer” for the current “client” to be removed from this role. Once a person is removed from their “Observer” role, they may then show up under the Available People list found on the “Group” setup screen. In one embodiment, this feature is only accessible by those with “Facilitator” (or higher) access rights.

The Change “Client” Terminology feature allows the “Facilitator” to change field names throughout the system software for the current “client” using the change terminology module 24. In one embodiment, this feature is only accessible by those with “Facilitator” (or higher) access rights. Client terminology refers to the labels used for people and commitments. These labels can be changed to meet the terminology needs for each client. In some embodiments, this terminology is client-specific and changing the field name labels in one client does not alter the field name labels for other clients.

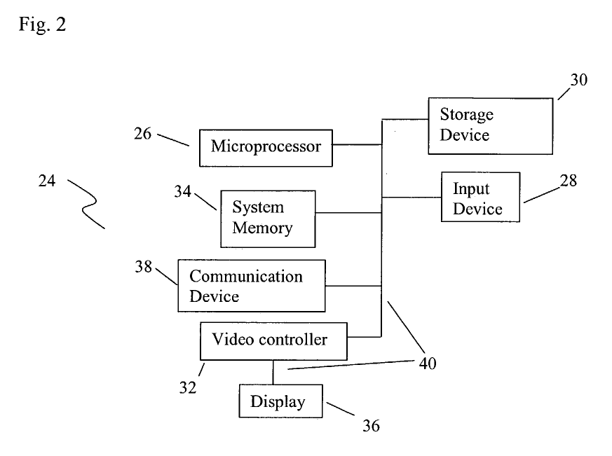

Referring to FIG. 2, an illustrative node 24 for implementing an embodiment of the method is depicted. Node 24 includes a microprocessor 26, an input device 28, a storage device 30, a video controller 32, a system memory 34, and a display 36, and a communication device 38 all interconnected by one or more buses 40. The storage device 38 could be a floppy drive, hard drive, CD-ROM, optical drive, or any other form of storage device. In addition, the storage device 38 may be capable of receiving a floppy disk, CD-ROM, DVD-ROM, or any other form of computer-readable medium that may contain computer-executable instructions. Further communication device 46 could be a modem, network card, or any other device to enable the node to communicate with other nodes across any form of network.

Referring now to FIG. 3, an example graphical representation of the people module 16 is shown. In this example, the people module 16 is represented using an HTML form with text fields 40 for first name, last name, initials (which may be automatically filled in by the software upon entering the first and last name), email address, and phone number. Once the user enters information into the text fields 40, the user selects the add button 42. When the add button 42 is selected, the people module 16 submits the information in the text fields 40 to the processing module 12 (FIG. 1).

Referring now to FIG. 4, an example graphical representation of the commitment module 18 is shown. The commitment module 18 has an assigned group 44, as well as a commitment name 46 and commitment description 48, where the user can name the commitment and provide a text description. Responsible party 50 is a dropdown menu that lists the people entered using the people module 16. Delegate party 52 is a dropdown menu that lists the people entered using the people module 16. A responsible party is an individual who is responsible for the particular commitment, while the delegate party is an individual who is responsible for physically performing the task. The review interval 54 is a time period that can be set to indicate how often the status of this particular commitment should be reviewed. The status field 56 indicates the current status of the commitment, and has the options of: Off Track, Needs Review, Critical Off Track, and Update Status.

Off Track: indicates that the commitment is no longer on-track and a popup box may appear which may require that a Reason Off Track and What To Do about getting the commitment back on-track be provided.

Needs Review: indicates that someone should review this commitment and a popup box may appear which may require a Reason For Review to be provided to indicate why a review should occur. If the email notification feature is on, then an email may automatically be sent to the Responsible Party with the review comment.

Critical Off Track: indicates that there is some serious issue with not being able to complete the commitment on time and could impact overall results. A popup box may appear which may a Reason Off Track and What To Do about getting the commitment back on-track be provided. If this Critical Off Track box is selected on a hierarchical commitment level below the commitment level, an email may be sent to the Responsible Party for the next hierarchical commitment level directly above indicating the Critical Off Track status of the commitment below. Also, the system may automatically change the Status selection to Needs Review for the commitment level above, which requires the Responsible Party to assess the implications and reevaluate the Status of this commitment.

Update Status: indicates that the system has automatically selected this Status and requires the Responsible Party to select an updated status for this commitment based on the selection choices discussed above. This can be applicable for the lowest level hierarchical commitment level “action item” to be discussed below.

In another embodiment, the particular commitment can be provided an estimated start date 58 and estimated completion date 60, as well as the actual start date 62 and actual completion date 64. The commitment module 18 also enables a user to upload a link to an electronic document (such as a word processor or spreadsheet document, although this could be used for any form of document), or the user could upload the actual electronic document.

In one embodiment, commitment module 18 may communicates with the processing module 12 (FIG. 1) to retrieve the list of people that were entered using people module 16 (FIG. 1). The list of people is displayed in people field 66. The user selects from a name from people field 66 and then selects the member button 68. After clicking button 68, the selected name is moved to the group field 70. In this manner, the user may designate which individuals will be associated with the commitment.

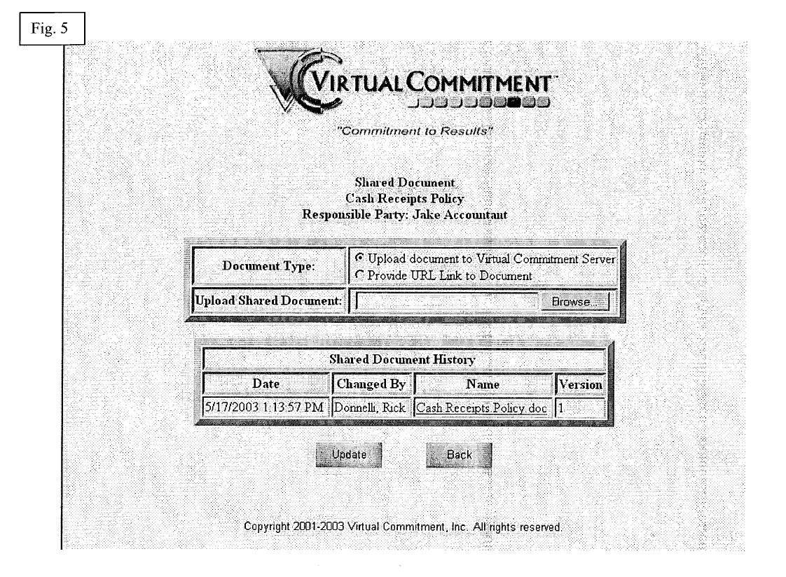

In another embodiment, a user may upload an electronic document (or link to the document is uploaded) for use with the commitment by selecting the upload link 72. In such event, the user may be prompted to provide the electronic document, and the system either receives the document or creates a logical reference to the electronic document. An example for such uploading is FIG. 5. Continuing with FIG. 4, the system generates a sub-commitment for each of the members of the group, and may send an email or other electronic communication to each of the members regarding the sub-commitment.

Alternatively, a user may require that each member of the group submit an electronic document to the system. In such an event, the system creates a sub-commitment for each member of the group, wherein a document must be received from a member in order for that member's sub-commitment to be accomplished.

When the desired information is input for a particular commitment, selecting the update button 74 causes the commitment module 18 to submit the information to the processing module 12 (FIG. 1).

Referring now to FIG. 6, an example graphical screen view 76 of multiple commitments is shown. The graphical screen view 76 is comprised of a number of shaped graphical images 78 connected to each other with various pieces of information listed on each graphical image. This embodiment may employ a number of visual descriptors:

Shape of node: Each one of the different commitment types (commitment, “subcommitment”, “strategy”, “action plan”, and “action item”) may have a different shape except for commitment and “sub-commitment” which are the same shape. For example, in this embodiment commitments and sub-commitments are denoted as trapezoids, strategies are pentagons, and action plans are octagons.

Commitment type name on node: First name listed on the node which indicates the commitment type (commitment, “sub-commitment”, “strategy”, “action plan”, and “action item”).

Color of node: If the commitment has a beginning start date that has not occurred yet, then the node may be in a “No Status” status and the color designation of “White=0 ” may display on the node. If the commitment has a beginning start date that has passed and the commitment has not been marked as being started, then the node may be in a “Not Started” status and the color designation of “Off White=1” may display on the node. If the commitment has been marked as being started and the completion date is not within 7 days or the completion date has not yet passed, then the node may be in a “Started” status and the color designation of “Light Blue=2” may display on the node. If the commitment has a completion date within 7 days and has not passed its completion date, then the node may be in a “Due This Week” status and the color designation of “Yellow=3” may display on the node. The system may automatically trigger an email to both the “Responsible Party” and the “Delegate Party” indicating that the specific commitment has reached the status of due this week. If the commitment has a color designation of “Light Orange=4” display on the node which represents “Needs Review”, then this indicates that either: 1)The “Review Interval” (daily, weekly, semimonthly or monthly, or other time period) has been triggered automatically by the processing module 18 (FIG. 1) and has set the “Status” selection to “Update Status” which requires a person to indicate their current “Status” for this commitment to be update and the update has not yet been made. The processing module 18 (FIG. 1) may automatically trigger an email after the system has triggered the “Status” field as “Update Status” to both the “Responsible Party” and the “Delegate Party” indicating that the specific commitment has not yet had it's Status field updated; or 2) A person has manually selected the “Needs Review” within the “Status” section of the commitment node. The system may automatically trigger an email to both the “Responsible Party” and the “Delegate Party” indicating that the specific commitment has been marked as needs review and may include the review comment and who originated the review comment. If the commitment has not reached it's completion date and has been manually marked as “Off Track” within the “Status” section of the commitment node, then the node may be in a “Off Track” status and the color designation of “Orange=5” may display on the node. If the commitment has a completion date which has passed and the commitment has not been marked as being completed, then the node may be in a “Past Due” status and the color designation of “Pink=6” may display on the node. The System may automatically trigger an email to both the “Responsible Party” and the “Delegate Party” indicating that the specific commitment has reached the status of past due. When a person manually selects the “Critical Off Track” within the “Status” section of the commitment node, then the node may be considered to be in the “Critical Off Track” status and the color designation of “Red=7” may display on the node. The system may automatically trigger an email to both the “Responsible Party” and the “Delegate Party” indicating that the specific commitment has been indicated to be critically off track. The system may also automatically trigger an email to the “Responsible Party” for the node directly above in the hierarchical structure and turn the hierarchical node above to a “Needs Review” status requiring the “Responsible Party” for that node to update the “Status” section on the commitment node. If the commitment has been marked as being completed, then the node may be in a “Completed” status and the color designation of “Green=9” may display on the node. (Note: If all the commitments under a given Action Plan are marked as completed, then the system may automatically change the color status on the Action Plan commitment to completed (e.g., green) and this process may automatically keep working itself up the hierarchical levels, until all the hierarchical levels are considered completed. All commitments for a given hierarchical level have to be completed in order for the commitment status at the next higher level to be considered completed.) With the appropriate access rights, an individual can manually mark a node as being “Cancelled,” then the node may be in a “Cancelled” status and the color designation of “Gray=10” may display on the node. This cancelled process can also be reversed by an individual manually marking this node as “Restore,” then the node may revert back to the status of its current state. An individual must first designate a node with a “cancelled” status prior to being able to “Delete” the node. If an individual can manually mark this node as “Delete”, then the node may disappear from the screen view and be forever gone and can not be latter restored. When a node is marked as “Cancelled,” then all the nodes below hierarchically the node marked as cancelled may also have a “cancelled” status and their color designation may be gray=10.

Underlined short description name on node: The name displayed on the node is the name given to the commitment upon original setup of the commitment.

Underlined “Responsible Party” initials on node: The initials on the bottom left of the node represent the “responsible party” for this commitment.

Underlined History (*H*) on node: The underlined (*H*) may appear if there has been a change to the information on this commitment, which creates history and all changes are logged to history.

Issue teardrop on node: If there is a particular issue that needs to be resolved for a commitment, then the graphical representation of that commitment may display an additional graphic 80. In this embodiment, a teardrop shaped graphic 80 is used. Further, the graphic 80 for the issue is linked to a sub-screen that will graphically display the commitments with respect to the issue, if any (“issue tree”). The issue tree may display the commitments graphically or in outline form, and may display multiple issues at once. In the issue tree, the user may update or revise the status of the issue, commitments, or sub-commitments. An example of an issue tree is depicted in FIG. 7. Continuing with FIG. 6, as the status of the issue or sub-commitments are updated, the processing module 18 (FIG. 1) will update the hierarchy related to the issue or sub-commitments, which may result in changes to the graphical representations of the issues, sub-commitments, and commitments as discussed herein.

In another embodiment, graphical module 20 may use an outline screen view. In this embodiment, the outline is displayed using HTML, with the conventions understand by one of ordinary skill of the art for using the minus sign (−) symbol to condense the view, and the plus sign (+) symbol to expand the view and show the hierarchical relationships between commitments. In addition, this embodiment may also use visual signals that are used in the graphical view to convey information to the use.

Referring now to FIG. 13 is an example 200 of the operation of the method for the invention. At step 202, the user may use a client setup module to enter the applicable information regarding a client and select the appropriate settings for the “Email Warning Enabled,” “Release Welcome Emails,” “Display Group Consultant,” and “Numerical Tracking Enabled.”

At step 204, the client terminology may be modified. Any one of the labels used to refer to individuals or commitments may be renamed to meet the terminology needs for each client. This terminology is client-specific and changing the field name labels in one client may not affect the field name labels for other clients.

At step 206, the individuals may be inputted using a people module to enter the applicable information about the people who may participate in attempting to achieve a particular commitment for a client.

At step 208, the welcome emails may be sent, if the “Release Welcome Emails” option was selected. At step 210, the groups may be setup and the roles of each of the people may be input using a group module.

At step 212, the commitments may be setup. Commitment is a term used to represent something that a person has committed to go do. It could represent a high level commitment or could represent a specific “action item” (task). The commitment Setup screen includes a couple of other fields such as the Status and Numerical Tracking. The Status field is a way to flag the current status of this particular commitment, but when a commitment is first setup, the default Status selection may be set to On Track. Potential states could include off track, needs review, critical off track, and update status.

In addition, the commitment setup may involve establishing multiple hierarchies of commitments, including strategies, action plans, and action items. For an action item, the user may need to input: “Action Item” Name; a description of the action item; a responsible party to be assigned the responsibility for seeing that this “action item” gets completed; a delegate party who is the person who may actually perform the work; the estimated start date; and the estimated completion date.

At step 214, the hierarchies of commitments are displayed to the user.

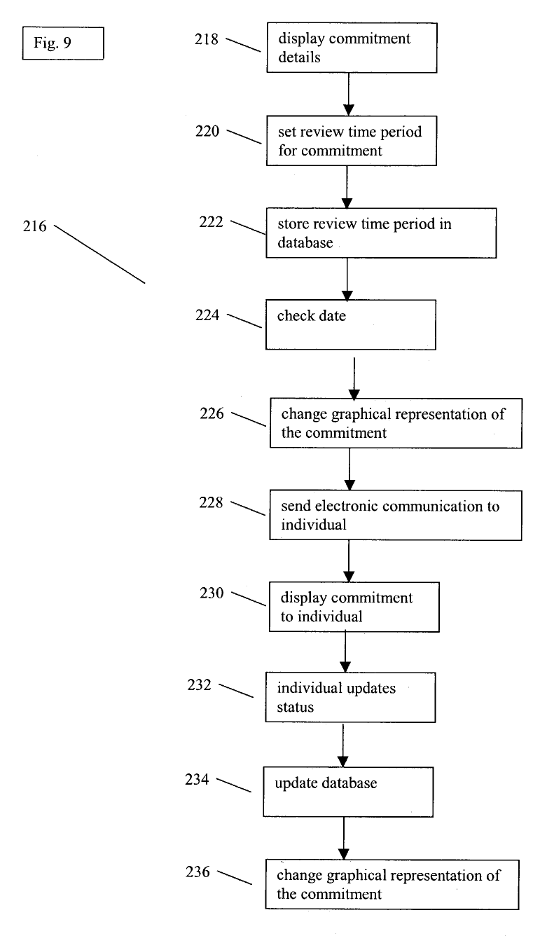

Referring now to FIG. 9 is an example 216 of the operation of the method for the invention. At step 218, the commitments are displayed to the user, possibly in graphical or outline form. The commitments can be any form of commitment, goal, or accomplish that an individual, group, or business may desire to accomplish. Further, additional sub-commitments could also be displayed at this time. At step 220, the user sets a review time period associated with a commitment. The review time period is a particular time period (e.g., daily, monthly, weekly, or any other time period) in which the status of a commitment is to be reviewed. The review time period is intended to be distinct from an estimated completion date. At step 222, the review time period is stored.

At step 224, the system will check the current change and determine whether the particular time period has occurred since the last update of the particular commitment. At step 226, the color of the graphical representation of the commitment is changed based on the status of the review time period with respect to the current date. For example, the graphical representation may change to light orange to represent “Needs Review” to indicate that the “Review Interval” (daily, weekly, semimonthly or monthly, or other time period) has occurred and the review has not yet been occurred. An email notification may also be sent to either or both the “Responsible Party” and the “Delegate Party” for the specific commitment. The system may automatically trigger an email to both the “Responsible Party” and the “Delegate Party” indicating that the specific commitment has been marked as needs review and may include the review comment and who originated the review comment. It is also contemplated that the system may update the database to reflect any changes to the status of the commitment based on the status of the review time period. For example, if the status of the review time period is “Needs Review,” the status of the associated commitment may be changed to “Off Track,” (or other applicable status) until the review occurs and changes the status of the review time period.

At step 228, an electronic communication, such as an email, can be sent to an individual, or individuals, who are responsible for the commitment, which may include the responsible party and/or the delegate party. At step 230, the responsible and/or delegate party views the commitment (which may have occurred by clicking a link within the electronic communication.

At step 232, the individual updates the status of the commitment. At step 234, the database is updated to reflect the change in status of the commitment. At step 236, the graphical representation of the commitment is updated to reflect to the change in status.

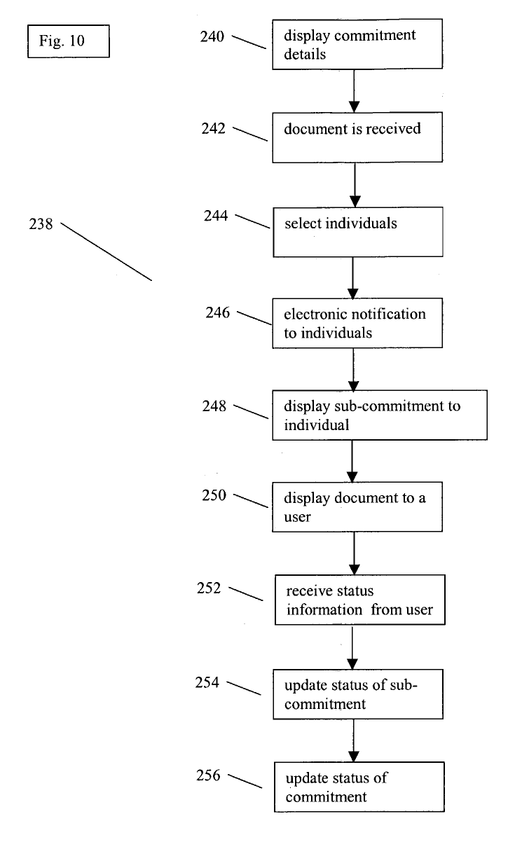

Referring now to FIG. 10 is an example 238 of the operation of the method for the invention. At step 240, the commitments are displayed to the user, possibly in graphical or outline form. The commitments can be any form of commitment, goal, or accomplish that an individual, group, or business may desire to accomplish. Further, additional sub-commitments could also be displayed at this time a list of names of individuals is stored. At step 242, an electronic document (such as a word processing document is received). Instead of, or in addition to, an electronic document, a link to a document could be received, such as a uniform resource locator (URL).

At step 244, the user will select a individuals for whom sub-commitments will be created. At step 246, an email or other electronic communication will be sent or transmitted to the individuals stored in the system. In one embodiment, the email will indicate to the individual that the electronic document should be reviewed, as well as containing a link to a graphical display of the commitments and sub-commitments.

At step 248, an individual will respond to the email (e.g., by clicking on a link in the email). A graphical display will show the commitments, which may include a commitment of “Review Document.” At step 250, the document is displayed to the user. At step 252, the individual will provide information status (such as indicating that the individual has reviewed the document) to the system and provide information as to the status of the commitment. At step 254, the system will update the status of the sub-commitment based on the response by the user. At step 256, the system will update the status of any related commitments or sub-commitments, if applicable. For example, there may be a commitment for “Group needs to review Document A,” and when the document is emailed to the group, sub-commitments of “Review Document A” are created for each member of the group. As each sub-commitment is completed, its status will reflect its completion. Once all of the sub-commitments are completed the “Group needs to review Document A” commitment will be updated as completed.

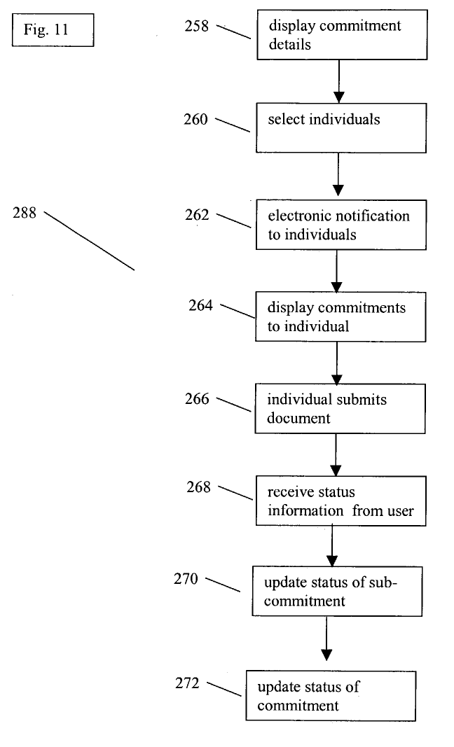

Referring now to FIG. 11 is an example 288 of the operation of the method for the invention. At step 258, the commitments are displayed to the user, possibly in graphical or outline form. The commitments can be any form of commitment, goal, or accomplish that an individual, group, or business may desire to accomplish. Further, additional sub-commitments could also be displayed at this time. At step 260, the user will select a individuals for whom sub-commitments will be created. At step 262, an email or other electronic communication will be sent or transmitted to the individuals stored in the system. In one embodiment, the email will indicate to the individual that the individual is required to submit a document to the system, and will contain a link to a graphical display of the commitments and sub-commitments.

At step 264, the user will respond to the email (e.g., by clicking on a link in the email). A graphical display will show the commitments, which may include a sub-commitment of “Submit Document.” At step 266, the individual may submit an electronic document (such as a word processing document) to the system. Instead of, or in addition to, an electronic document, a link to a document could be received, such as a uniform resource locator (URL). For example, the individual might submit a memorandum or a sales report, or any other document that may be important to a commitment, or that could help accomplish a commitment.

At step 268, the individual provides status information as to the status of the sub-commitment. At step 270, the graphical display displays the sub-commitment, and the graphical display of the sub-commitment is linked to the submitted electronic document. At step 272, the status of the commitment is updated to reflect the change in status of the sub-commitment.

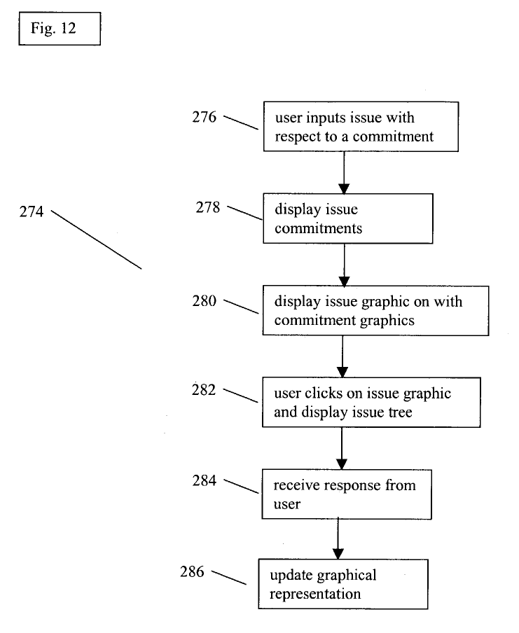

Referring now to FIG. 12 is an example 274 of the operation of the method for the invention. At step 276, a user inputs an issue into the system. An issue may be an event that impacts the ability to successfully accomplish a particular commitment or sub-commitment. When inputting the issue, the user may also input commitments and any related sub-commitments desirable to facilitate resolving the issue. At step 278, the graphical representation of the commitments and sub-commitments that are needed to resolve the issue are displayed. One such manner is by displaying the commitments in a hierarchy that shows the relationships between the different commitments and sub-commitments. At step 280, a graphical representation of the issue will be displayed in relation to the graphical representation of the primary commitment to which the issue applies. In one embodiment, the graphical representation of the issue may be a teardrop that is depicted as hanging off of the graphical representation of the commitment. The teardrop is clickable by the user, and is connected to the graphical representation of the issue tree.

At step 282, the user clicks on the graphical representation of the issue, and the system displays the graphical representation of the issue tree. At step 284, the user provides status information as to the status of the commitments associated with the issue tree. At step 286, the system updates the graphical representation of the issue based on the status information supplied by the user.

Additional advantages and features of the present invention may become apparent from the following description and appended claims, taken in conjunction with the accompanying illustrations. It should be understood that the detailed descriptions and specific examples, while indicating the preferred embodiments of the invention, are intended for the purposes of illustration only and are not intended to limit the scope of the invention. Thus, variations that do not depart from the gist of the invention are intended to be within the scope of the invention. Such variations are not to be regarded as a departure from the spirit and scope of the invention.

We claim:

1. A method of electronic commitment tracking, comprising:
storing at least one commitment;
storing a review time period associated with the at least one commitment;
changing a color of a graphical depiction of the at least one commitment based on the status of the review time period; and
receiving status information from a user with respect to the at least one commitment.

2. The method of claim 1, further comprising:
updating a graphical depiction of the at least one commitment based on the status information received from the user.

3. A method of electronic commitment tracking, comprising:
storing a list of names of a plurality of individuals;
receiving an electronic document;
sending an electronic communication to a plurality of electronic addresses corresponding to the plurality of individuals;
creating a sub-commitment of a first commitment and displaying a graphical representation of the first commitment to at least one of the individuals;
displaying the electronic document to the at least one individual;
receiving information from the at least one individual with respect to the status of the sub-commitment;
updating a status of the sub-commitment based the information; and
updating a status of the first commitment based on the status of the sub-commitment.

4. The method of claim 3, further comprising:
displaying a graphical representation of the sub-commitment.

5. The method of claim 3, further comprising:
displaying the graphical representation of the first commitment.

6. The method of claim 3, wherein the receiving of an electronic document receives a link to an electronic document.

7. A method of electronic commitment tracking, comprising:
storing a list of names of a plurality of individuals;
sending an electronic communication to a plurality of electronic addresses corresponding to the plurality of individuals;
displaying a graphical representation of a commitment to at least one of the plurality of individuals;
receiving an electronic document from the at least one individual;
receiving information from the at least one individual with respect to the status of a sub-commitment related to the commitment; and
displaying a graphical representation of the sub-commitment such that the graphical representation is logically connected to the electronic document.

8. A method of electronic commitment tracking, comprising:
storing a plurality of commitments;
storing an issue relating to at least one of the plurality of commitments;
displaying a graphical representation of the plurality of commitments;
displaying a graphical representation of the issue such that the graphical representation is logically connected to a graphical representation of an issue tree;
displaying the graphical representation of the issue tree;
receiving information with respect to a status of a commitment applicable to the issue; and
updating the graphical representation of the issue.
